(19) United States
(12) Patent Application Publication
(10) Pub. No.: US 2016/0156257 A1
(43) Pub. Date: Jun. 2, 2016

(54) Magnetic Coupling

(71) Applicant: Ricardo UK Limited, West Sussex (GB)

(72) Inventors: Andrew Farquhar Atkins, West Sussex (GB); Richard Gordon, West Sussex (GB); Peter Stubberfield, West Sussex (GB); Pascal Revereault, West Sussex (GB)

(21) Appl. No.: 15/006,842

(22) Filed: Jan. 26, 2016

Related U.S. Application Data
(63) Continuation of application No. PCT/GB2014/052295, filed on Jul. 25, 2014.

(30) Foreign Application Priority Data
Jul. 26, 2013 (GB) 1313427.5

(51) Int. Cl. H02K 49/10; H02K 7/102; H02K 7/02

(52) U.S. Cl. CPC H02K 49/102; H02K 7/025; H02K 7/102

(57) ABSTRACT

A magnetic coupling including a first member having a first array of magnetic field generating elements, the first member being arranged to produce first moving magnetic field, an array of electrical conductors fixed relative to the first member, and a second member having a second array of magnetic field generating elements, the second member being arranged to produce second moving magnetic field, wherein the first and second members are arranged for relative movement therebetween, wherein the array of conductors is arranged to inductively couple with the second moving magnetic field to produce a torque to bring the first and second moving magnetic fields into synchronous relative movement.

### CROSS-REFERENCE TO RELATED APPLICATIONS

The present application is a continuation of International Application No. PCT/GB2014/052295 filed Jul. 25, 2014, which claims priority from Great Britain Application No. 1313427.5 filed Jul. 26, 2013, all of which are incorporated herein by reference.

### BACKGROUND OF THE INVENTION

The present disclosure relates a magnetic coupling, for example a magnetic gear.

Magnetic couplings allow contactless transmission of kinetic energy from a first moving member to a second moving member. This can reduce energy losses across the coupling and also enables isolation of drive and driven components. This isolation allows the environment within which the driven member is placed to be sealed from the drive component, allowing, for example, the driven component to be placed within a chamber whose environment can be separately controlled, for example the chamber may be placed under vacuum or low pressure or may contain a low viscosity gas such as Helium. Isolation of the driven member may also be advantageous in pumps because it can allow, for example, noxious or corrosive substances being pumped to be isolated from the drive component.

The inventors in the present case have appreciated that inefficiencies in transmitting energy across a magnetic coupling, for example due to energy losses from inductive heating, may lead to significant loss of performance, particularly in the case where the magnetic coupling is a geared magnetic coupling used to amplify a high torque, low frequency input drive to produce a low torque, high frequency output. Housing the driven component of the magnetic coupling in a vacuum or low pressure chamber helps reduce such losses, but the heating effects caused by hysteresis and eddy currents may still impair efficiency. Additionally, improved control may be required for managing the magnetic coupling and in particular for extracting heat from the input (driving) side.

### BRIEF SUMMARY OF THE INVENTION

Aspects and examples of the invention are set out in the claims.

Embodiments of the present disclosure provide apparatus and methods which aim to facilitate increased efficiency and improved control of magnetic couplings, including magnetic gears, and in particular magnetic flywheels.

In a first aspect, there is provided a magnetic coupling comprising:
a first member having a first array of magnetic field generating elements, the first member being arranged to produce first moving magnetic field;
an array of electrical conductors fixed relative to the first member; and
a second member having a second array of magnetic field generating elements, the second member being arranged to produce second moving magnetic field, wherein the first and second members are arranged for relative movement therebetween, wherein:
the array of conductors is arranged to inductively couple with the second moving magnetic field to produce a torque to bring the first and second moving magnetic fields into synchronous relative movement.

In an embodiment, the array of electrical conductors comprises a plurality of electrically conductive coupling elements arranged to couple each electrical conductor in the array to another electrical conductor in the array to provide a plurality of electrically conductive circuits.

In an embodiment, the array of electrical conductors and electrical coupling elements form a squirrel cage.

In an embodiment, consecutive electrical conductors of the electrical conductor array are arranged intermediate consecutive magnetic field generating elements of the first array of magnetic field generating elements.

In an embodiment, there is provided a means for changing the speed of at least one of the first and second moving magnetic fields.

In an embodiment, a controller configured to control the speed of the first moving magnetic field.

In an embodiment, there is provided a controller configured to control the speed of the second moving magnetic field.

In an embodiment, there is provided a mechanical brake configured to decrease the speed of a moving one of the first and second members.

In an embodiment, the first array comprises an array of permanent magnetic poles, wherein the first member is arranged to rotate to provide the first moving magnetic field.

In an embodiment, the second array comprises an array of permanent magnetic poles, wherein the second member is arranged to rotate to provide the second moving magnetic field.

In an embodiment, the permanent magnetic poles of the first array of magnetic field generating elements comprises a Halbach array to provide a higher proportion of the overall magnetic field of the magnetic coupling on the side of the first member compared to the side of the second member to help to concentrate heating effects arising from the coupling of magnetic flux between the first and second arrays of magnetic field generating elements on the side of the first member. In an embodiment, the Halbach array is oriented to provide a higher or consolidated magnetic field on the side of the first array of magnetic field generating elements which faces towards the second array of magnetic field generating elements to increase the amount of magnetic flux coupled between the first array of magnetic field generating elements and the second array of magnetic field generating elements. In an embodiment, the orientation of consecutive permanent magnetic poles in the Halbach array varies by less than 90 degrees.

In an embodiment, one of the first and second members is arranged within a chamber, wherein the chamber may be at vacuum or low pressure or contain a low viscosity gas such as Helium.

In an embodiment, the first array of magnetic field generating elements comprises m magnetic field generating elements and the second arrays of magnetic field generating elements comprises n magnetic field generating elements so as to provide a magnetic gear having a gear ratio of n:m when the first and second moving magnetic fields are brought into synchronous relative movement.

In an embodiment, there is provided a coupling member, the coupling member being configured to couple magnetic flux between the first array of magnetic field generating elements and the second array of magnetic field generating elements.

In an embodiment, the coupling member forms part of a barrier enclosing the chamber.

In an embodiment, the first member, coupling member and second member are arranged concentrically, wherein wherein the coupling member is provided intermediate the first and second members for coupling magnetic flux between the first and second arrays in a radial direction.

In an embodiment, the first and second members are axially spaced apart, wherein the coupling member is provided intermediate the first and second members for coupling magnetic flux between the first and second arrays in an axial direction.

In an embodiment, the first member, the second member and the coupling member are arranged coaxially.

In an embodiment, the coupling member comprises a plurality of coupling elements for coupling the flux.

In an embodiment, the coupling member has an outer circumferential surface.

In an embodiment, the outer circumferential surface is configured to carry the coupling elements.

In an embodiment, the outer circumferential comprises a plurality of recesses for supporting the plurality of coupling elements therein.

In an embodiment, the recesses are configured such that outer surfaces of the respective coupling elements carried therein are flush with the outer circumferential surface.

In an embodiment, the coupling elements are provided beneath the outer circumferential surface.

In an embodiment, the coupling member has an inner circumferential surface.

In an embodiment, inner surfaces of the respective coupling elements are flush with the inner circumferential surface.

In an embodiment, the coupling elements are provided beneath the inner circumferential surface.

In an embodiment, one of the first and second members is coupled to an input rotor and the other is coupled to a flywheel.

In an embodiment, the first member is coupled to an input rotor and the second member of coupled to a flywheel.

In an embodiment, the magnetic coupling is provided within a vehicle and the flywheel is coupled to a drive system of the vehicle.

An embodiment comprises:
causing the array of conductors to produce a torque on the second member by effecting asynchronous relative movement between the first moving magnetic field and the second moving magnetic field.

In a second aspect, there is provided an energy storage system comprising a magnetic coupling, the energy storage system comprising:
a housing defining a chamber;
a first member arranged outside the chamber, the first member having a first array of magnetic field generating elements;
a second member arranged inside the chamber, the second member having a second array of magnetic field generating elements, the first and second members being arranged for relative movement;
wherein one of the first and second members is coupled to a flywheel for storing energy to power the vehicle;
wherein the chamber may be at vacuum or low pressure or contain a low viscosity gas such as Helium; and wherein
at least one of the first array of magnetic field generating elements and second array of magnetic field generating elements comprises a Halbach array. In an embodiment, this may provide a higher proportion of the overall magnetic field of the magnetic coupling on the side of the first member compared to the side of the second member to help to concentrate heating effects arising from the coupling of magnetic flux between the first and second arrays of magnetic field generating elements on the side of the first member.

In an embodiment, the orientation of consecutive permanent magnetic poles in the Halbach array may vary by less than 90 degrees. The energy storage system may further comprise a coupling member, the coupling member being configured to couple magnetic flux between the array first array of magnetic field generating elements and the second array of magnetic field generating elements. The coupling member may form part of the housing enclosing the chamber. The first member, coupling member and second member may be arranged concentrically, wherein the coupling member is provided intermediate the first and second members for coupling magnetic flux between the first and second arrays in a radial direction. The first and second members may be axially spaced apart, wherein the coupling member is provided intermediate the first and second members for coupling magnetic flux between the first and second arrays in an axial direction. The first member, the second member and the coupling member may be arranged coaxially. The coupling member may comprise a plurality of elements for coupling the flux.

In an embodiment, the coupling member may have an outer circumferential surface. The outer circumferential surface may be configured to carry the coupling elements. The outer circumferential may comprise a plurality of recesses for supporting the plurality of coupling elements therein. The recesses may be configured such that outer surfaces of the respective coupling elements carried therein are flush with the outer circumferential surface. The coupling elements may be provided beneath the outer circumferential surface. The coupling member may have an inner circumferential surface. Inner surfaces of the respective coupling elements may be flush with the inner circumferential surface. The coupling elements may be provided beneath the inner circumferential surface. One of the first and second members may be coupled to an input rotor and the other may be coupled to the flywheel, for example the first member may be coupled to the input rotor and the second member may be coupled to the flywheel. The magnetic coupling may be provided within a vehicle and the flywheel is coupled to a drive system of the vehicle.

In an embodiment, the energy storage system may further comprise an array of electrical conductors fixed relative to the first member, wherein the array of electrical conductors is arranged to inductively couple with the second moving magnetic field to produce a torque to bring the first and second moving magnetic fields into synchronous relative movement. The array of electrical conductors may comprise a plurality of electrically conductive coupling elements arranged to couple each electrical conductor in the array to another electrical conductor in the array to provide a plurality of electrically conductive circuits.

In an embodiment, the array of electrical conductors and electrical coupling elements may form a squirrel cage.

In an embodiment, the consecutive electrical conductors of the electrical conductor array may be arranged intermediate consecutive magnetic field generating elements of the first array of magnetic field generating elements.

In an embodiment, the magnetic coupling may comprise a means for changing the speed of at least one of the first and second moving magnetic fields.

In an embodiment, the magnetic coupling may comprise a controller configured to control the speed of the first moving magnetic field.

In an embodiment, the magnetic coupling may comprise a controller configured to control the speed second moving magnetic field.

In an embodiment, the magnetic coupling may comprise a mechanical brake configured to decrease the speed of a moving one of the first and second members.

In a third aspect, there is provided a magnetic coupling comprises:
a first member having a first array of magnetic field generating elements, the first member being arranged to produce first moving magnetic field;
a second member having a second array of magnetic field generating elements, the second member being arranged to produce second moving magnetic field, wherein the first and second members are arranged for relative movement therebetween; and
a controller configured to control coupling and decoupling of the magnetic coupling.

The controller may be configured to track at least one of: the speeds of the first moving magnetic field and the second moving magnetic field; and the speed of relative movement of between the first member and the second member.

The controller may be configured to determine whether or not the first and second moving magnetic fields are synchronously coupled.

The controller may be configured to control the speed of the first of the second moving magnetic field.

The controller may be configured, in response to determining that the first and second moving magnetic fields are synchronously coupled, to cause a change in the speed of the first or the second moving magnetic field to move the magnetic coupling from synchronicity.

The controller may be configured, in response to determining that the first and second moving magnetic fields are not synchronously coupled, to cause a change in the speed of the first or second moving magnetic field to establish synchronicity.

Determining that the first and second moving magnetic fields are not synchronously coupled may comprise determining that the speed of relative movement of the first and second moving magnetic fields is slower than the speed associated with synchronicity, and wherein causing a change in the speed of the first or second moving magnetic field to establish synchronicity comprises causing the speed the first or second moving magnetic field to increase beyond the speed associated with synchronicity and allowing the speed of the first or second moving magnetic field to slow down to the speed associated with synchronicity.

The magnetic coupling may comprise: an array of electrical conductors fixed relative to the first member, wherein: the array of conductors is arranged to inductively couple with the second moving magnetic field to produce a torque to bring the first and second moving magnetic fields into synchronous relative movement.

The array of electrical conductors may comprise a plurality of electrically conductive coupling elements arranged to couple each electrical conductor in the array to another electrical conductor in the array to provide a plurality of electrically conductive circuits.

The array of electrical conductors and electrical coupling elements may form a squirrel cage.

Consecutive electrical conductors of the electrical conductor array may arranged intermediate consecutive magnetic field generating elements of the first array of magnetic field generating elements.

The magnetic coupling may comprise a means for changing the speed of at least one of the first and second moving magnetic fields.

The magnetic coupling may comprise a controller configured to control the speed of the first moving magnetic field.

The magnetic coupling may comprise a controller configured to control the speed of the second moving magnetic field.

The magnetic coupling may comprise a mechanical brake configured to decrease the speed of a moving one of the first and second members.

The first array may comprise an array of permanent magnetic poles, wherein the first member is arranged to rotate to provide the first moving magnetic field.

The second array may comprise an array of permanent magnetic poles, wherein the second member is arranged to rotate to provide the second moving magnetic field.

The permanent magnetic poles of the first array of magnetic field generating elements may comprise a Halbach array to provide a higher proportion of the overall magnetic field of the magnetic coupling on the side of the first member compared to the side of the second member to help to concentrate heating effects arising from the coupling of magnetic flux between the first and second arrays of magnetic field generating elements on the side of the first member.

The Halbach array may be oriented to provide a higher or consolidated magnetic field on the side of the first array of magnetic field generating elements which faces towards the second array of magnetic field generating elements to increase the amount of magnetic flux coupled between the first array of magnetic field generating elements and the second array of magnetic field generating elements.

The orientation of consecutive permanent magnetic poles in the Halbach array may vary by less than 90 degrees.

One of the first and second members may be arranged within a chamber wherein the chamber may be at vacuum or low pressure or contain a low viscosity gas such as Helium.

The first array of magnetic field generating elements may comprise m magnetic field generating elements and the second arrays of magnetic field generating elements comprises n magnetic field generating elements so as to provide a magnetic gear having a gear ratio of n:m when the first and second moving magnetic fields are brought into synchronous relative movement.

The magnetic coupling may comprise a coupling member, the coupling member being configured to couple magnetic flux between the first array of magnetic field generating elements and the second array of magnetic field generating elements.

The coupling member may form part of a barrier enclosing the chamber.

The first member, coupling member and second member may be arranged concentrically, wherein wherein the coupling member is provided intermediate the first and second members for coupling magnetic flux between the first and second arrays in a radial direction.

The magnetic gear of claim 83 or 84, wherein the first and second members are axially spaced apart, wherein the coupling member is provided intermediate the first and second members for coupling magnetic flux between the first and second arrays in an axial direction.

The first member, the second member and the coupling member may be arranged coaxially.

The coupling member may comprise a plurality of coupling elements for coupling the flux.

The coupling member may have an outer circumferential surface.

The outer circumferential surface may be configured to carry the coupling elements.

The outer circumferential may comprise a plurality of recesses for supporting the plurality of coupling elements therein.

The recesses may be configured such that outer surfaces of the respective coupling elements carried therein are flush with the outer circumferential surface.

The coupling elements may be provided beneath the outer circumferential surface.

The coupling member may have an inner circumferential surface.

Inner surfaces of the respective coupling elements may be flush with the inner circumferential surface.

The coupling elements may be provided beneath the inner circumferential surface.

One of the first and second members may be coupled to an input rotor and the other is coupled to a flywheel.

The first member may be coupled to an input rotor and the second member of coupled to a flywheel.

The magnetic coupling may be provided within a vehicle and the flywheel is coupled to a drive system of the vehicle.

A fourth aspect provides a method of operating a magnetic coupling comprising a first member having a first array of magnetic field generating elements, the first member being arranged to produce first moving magnetic field, a second member having a second array of magnetic field generating elements, the second member being arranged to produce second moving magnetic field, wherein the first and second members are arranged for relative movement therebetween, and a controller configured to control coupling and decoupling of the magnetic coupling, the method comprising:
effecting relative movement between the first and second members;
receiving, at the controller, an indication of the speed of at least one of the first and second members; and
controlling the speed of at least one of the first and second members based on the indication of the speed of the at least one of the first and second members to couple or decouple the magnetic coupling.

The method may comprise determining whether or not the magnetic coupling is synchronously coupled based on the indication of the speed of the at least one of the first and second members.

The method may comprise controlling the speed of the at least one of the first and second members to decouple the synchronous coupling when a synchronous coupling is determined.

Controlling the speed of the at least one of the first and second members to decouple the synchronous coupling may comprise increasing the speed of the second member to take the second member past a speed associated with synchronicity and maintaining the second member at the new speed to prevent recoupling.

The method may comprise controlling the speed of the at least one of the first and second members to establish a synchronous coupling, when a synchronous coupling is not determined.

Controlling the speed of the at least one of the first and second members to establish a synchronous coupling may comprise increasing the speed of the second member past a speed associated with synchronicity and allowing the speed of the second member to slow down to the speed associated with synchronicity.

The method may comprise receiving, at the controller, indications of the speeds of both of the first and second members and determining whether or not the magnetic coupling is synchronously coupled based on the indications.

The magnetic coupling may comprise a magnetic gear, the method comprising determining the whether or not the magnetic coupling is synchronously coupled based on the indications and a gear ratio of the magnetic gear.

The method may comprise determining a power demand requirement of a drive system to which the second member is coupled and controlling the speed of the at least one of the first and second members based on the power demand requirement.

### BRIEF DESCRIPTION OF THE DRAWINGS

Embodiments of the invention will now be described, by way of example only, with reference to the accompanying drawings in which:

FIG. 1 is a schematic illustration through an axial cross-section of a magnetic gear;

FIG. 1a shows a schematic axial cross-section of part of a coupling member;

FIG. 2a is a schematic illustration of a first example of a Halbach array;

FIG. 2b is a schematic illustration of a second example of a Halbach array;

FIG. 3 is a schematic illustration of an arrangement for controlling a magnetic gear in a vehicle;

FIG. 4a is a schematic illustration of an electrically conductive squirrel cage;

FIG. 4b is a schematic illustration of an array of magnetic field generating elements;

FIG. 4c is a schematic illustration of a first member of a magnetic gear comprising the electrically conductive squirrel cage of FIG. 4a and the array of magnetic field generating elements of FIG. 4b;

FIG. 5a shows a cross section through a diameter of a non-concentric magnetic gear; and

FIG. 5b shows a partial cut-away view of the non-concentric magnetic gear shown in FIG. 5a.

### DETAILED DESCRIPTION

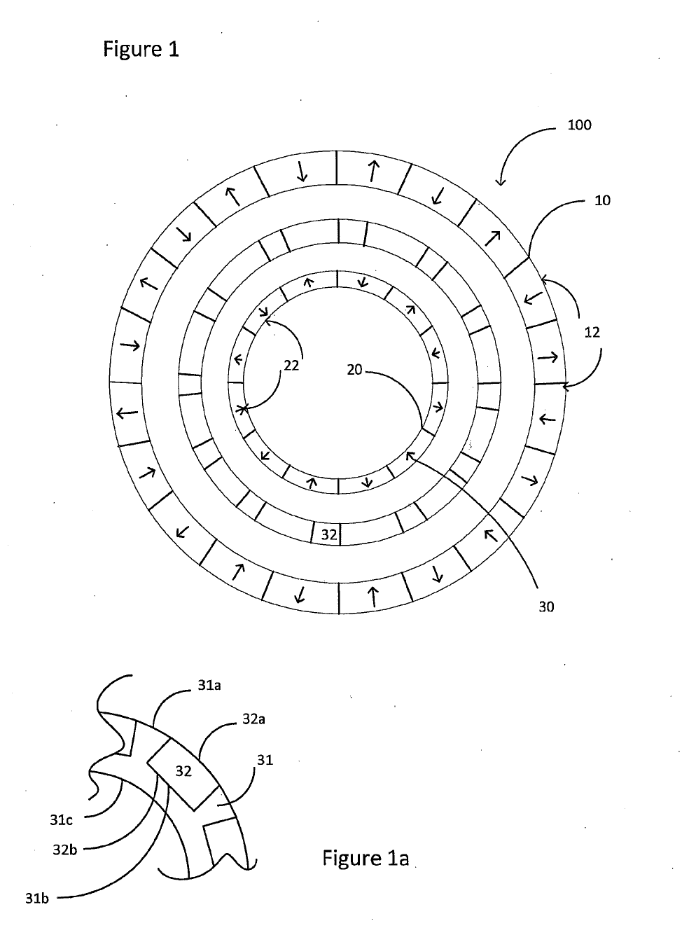

FIG. 1 shows an axial cross-section through a magnetic gear 100, the magnetic gear 100 comprising a first member 10, a second member 20 and a coupling member 30. The first member 10 has a first array of magnetic field generating elements 12. The second member 20 has a second array of magnetic field generating elements 22. The coupling member 30 has an array of coupling elements 32. The first member 10, second member 20 and coupling member 30 all have an axial extent.

The first member 10, the coupling member 30 and the second member 20 are arranged concentrically. The first member 10 and the second member 20 are arranged for relative rotation about a common axis. The coupling member 30 is provided intermediate the first member 10 and the second member 20 to couple magnetic flux between the first and second arrays of magnetic field generating elements 12, 22 in a radial direction.

The first member 10 is arranged for rotation with an input rotor (not shown).

The first member 10 comprises a non-conductive material (not shown), and the first array of magnetic field generating elements 12 are provided in the non-conductive material 31 such that consecutive magnetic field generating elements 12 are spaced apart by the non-conductive material. The first array of magnetic field generating elements 12 comprises an array of m permanent magnetic poles, in which consecutive magnetic poles are of opposite polarity as represented by the arrows in FIG. 1. The magnetic field generating elements 12 may be fully or partially embedded in the non-conductive material.

The second member 20 is coupled to a flywheel (not shown) for rotation with the flywheel. The second member 30 and the flywheel are arranged in a chamber 40 which may be maintained under a vacuum or at low-pressure. In another example, the chamber 40 may contain a gas other than air, in particular a gas having a lower viscosity than air, such as Helium.

The second member 20 comprises a non-conductive material (not shown), and the second array of magnetic field generating elements 22 are provided in the non-conductive material such that consecutive magnetic field generating elements 22 are spaced apart by the non-conductive material. The magnetic field generating elements 22 may be fully or partially embedded in the non-conductive material.

The second array of magnetic field generating elements 22 comprises an array of n permanent magnetic poles, in which consecutive magnetic poles are of opposite polarity as represented by the arrows in FIG. 1.

The number of magnetic field generating elements, m, of the first member 10 is larger than the number of magnetic field generating elements, n, of the second member 20. The illustrated gear therefore provides a step-up gear from the first member 10 (and input rotor) to the second member 20 (and output rotor/flywheel), wherein when the first and second members 10, 20 are in synchronous relative rotation, the second member 20 rotates faster than the first member 10 by a factor of n/m, where n/m is the gear ratio of the magnetic gear 100.

In this example, the coupling member 30 forms part of a barrier at least partially enclosing the chamber 40 containing the second member 20. The barrier may form part of a housing of the chamber 40. As illustrated in the cross-sectional view in FIG. 1a of part of the coupling member 30, the coupling member 30 comprises a non-conductive material 31 having an outer circumferential surface 31a with a plurality of recesses 31b for supporting coupling elements of the array of coupling elements 32. The recesses are 31b spaced apart around the outer circumferential surface 31a such that consecutive coupling elements 32 are spaced apart by the non-conductive material 31. The recesses 31b are such that outer surfaces 32a of the coupling elements 32 (surfaces that face away from the chamber 40) received in the recesses may be flush with the outer circumferential surface of the coupling member 30. Inner circumferential surfaces 32b of the coupling elements 32 (surfaces that face towards the chamber 40) may be provided beneath an inner circumferential surface 31c of the coupling member 30. In this way the coupling elements 32 are sealed from the chamber 40 by a layer of the non-conductive material 31 of the coupling member 30.

The coupling elements or pole pieces 32 comprise a magnetically permeable material, for example a ferrous or ferrite material. The coupling elements 32 are in this example elongate in the axial direction and may have a rectangular cross-section. In use the coupling elements 32 couple magnetic flux from the first array of magnetic field generating elements 12 to the second array of magnetic field generating elements 22 to permit synchronous relative rotation of the first and second arrays. Synchronous relative rotation corresponds to the magnetic gear being in a coupled configuration in which the second member 20 rotates at n/m times the speed of the first member 10.

As used herein the phrase “non-conductive material” means a material which is electrically non-conductive or electrically semi-insulating and which has a relative permeability close to 1, such as a ceramic, plastic or composite material. The magnetic field generating elements may be any suitable form of permanent magnetic poles such as rare earth magnets. The magnetic field generating elements 12 will generally be equally sized. Similarly, the magnetic field generating elements 22 will generally be equally sized. Also, the coupling elements 32 will generally be equally sized and equally spaced.

Generally, in use of the magnetic coupling the first member 10 will be coupled to an input rotor (which may for example be or be coupled to a drive shaft of a motor or a pump input drive) and the second member 20 will be coupled to an output rotor (which may be for example be or be coupled to a flywheel or a pump impeller).

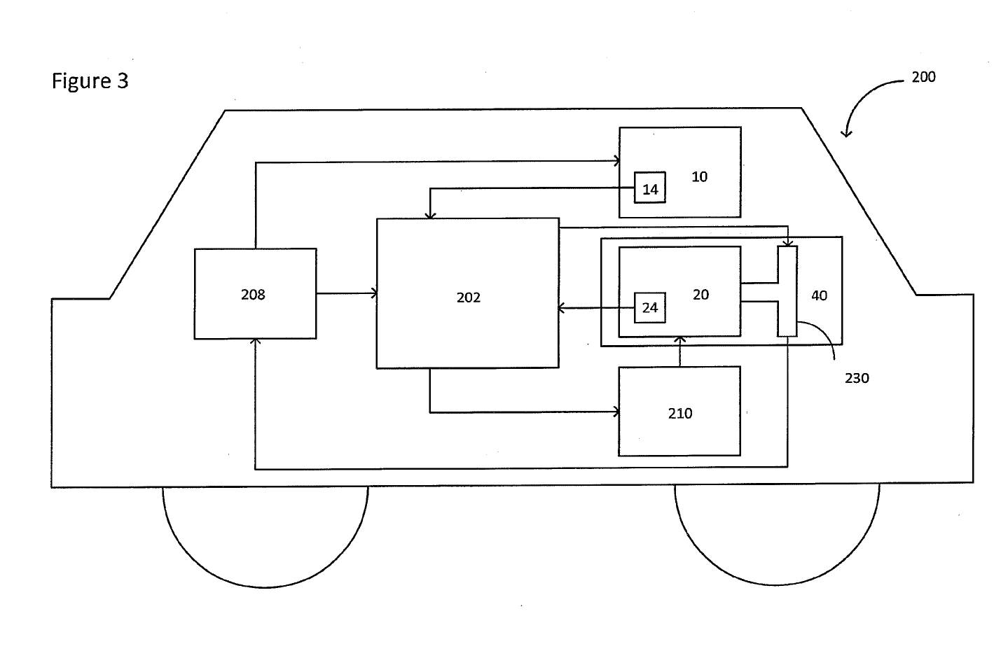

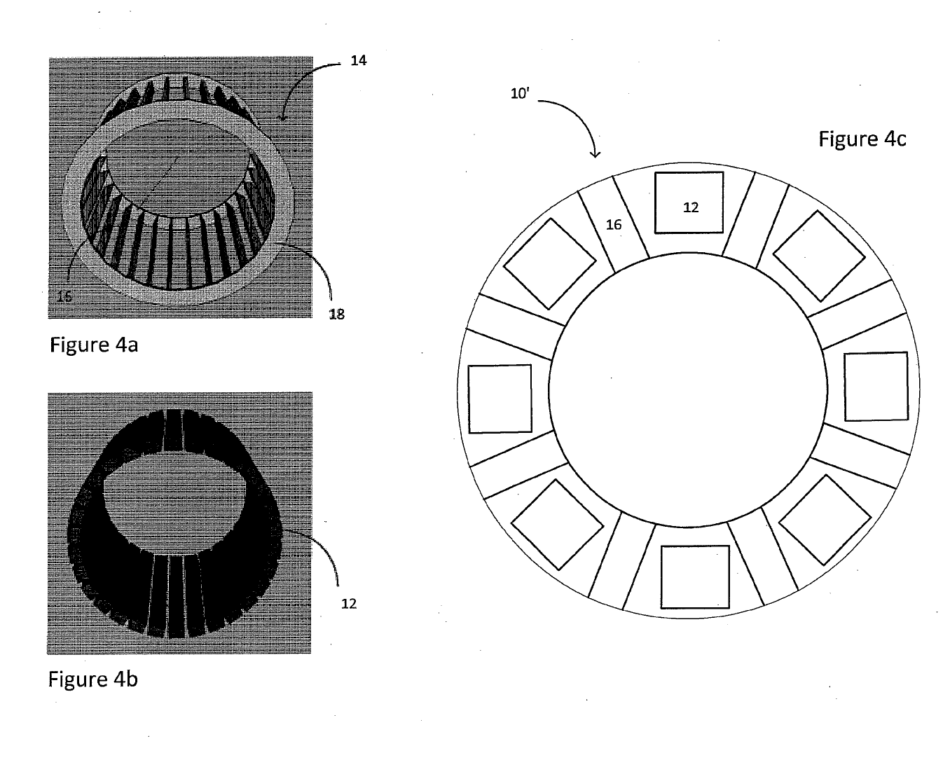

In operation, rotation of the input rotor causes rotation of the first member 10, and the rotation of the first array of magnetic field generating elements 12 generates a first moving magnetic field. When the magnetic gear 100 is coupled with the first member 10 rotating to provide a first moving magnetic field and the second member rotating to provide a second moving magnetic field via rotation of the second array of magnetic field generating elements 22, the coupling elements 32 couple the first and the second moving magnetic fields to maintain synchronous relative rotation of the first and second members 10, 20. Synchronism may be established, or re-established if lost, by a control arrangement such as that shown in FIG. 3, and/or by means of a squirrel cage fixed for rotation with one of the first and second members 10, 20 as shown in FIGS. 4a to 4c, both of which will be described below.

In an example, at least one of the first and second arrays of magnetic field generating elements 12, 22 comprises a Halbach array. In a Halbach array, magnetic field generating elements are arranged so that the overall resulting magnetic field is consolidated, or is much stronger, on one longitudinal side of the array than on the opposite longitudinal side to the extent that the magnetic field provided on the opposite side of the array is weak or even zero or near zero. By providing at least one of the first and second arrays of magnetic field generating elements 12, 22 by way of a Halbach array oriented so as to provide the consolidated magnetic field in the direction of the other of the first and second arrays of magnetic field generating elements 12, 22, the amount of flux coupled between the first and second arrays 12, 22 may be increased. By providing one of the first and second arrays of magnetic field generating elements 12, 22 by way of a Halbach array and the other as a non-Halbach array, the magnetic field across the magnetic gear 200 may be “skewed” such that the difference in magnetic field strength between the first array of magnetic field generating elements 12 and second array of magnetic field generating elements 22 is larger than in the case where both of the first and second arrays 12, 22 are non-Halbach. This may have the effect of concentrating eddy current and hysteresis heating on the side of the magnetic gear 200 having the Halbach array. Therefore, in an example, the first array of magnetic field generating elements 12 is provided by a Halbach array oriented so that the consolidated magnetic field faces towards the second array of magnetic field generating elements 22. This may both improve flux coupling across the magnetic gear 200 compared to the case in which the first array of magnetic field generating elements 12 is not a Halbach array, and may concentrate the eddy current and hysteresis heating on the side of the first member 10, and therefore away from the chamber 40, where the heat may be more easily removed. The increased amount of flux coupling provided by the Halbach array allows the gap between the first array of magnetic field generating elements 12 (provided by the Halbach array) and the coupling member 30 to be made wider than in the case where a Halbach array is not provided, because the increased amount of flux coupling arising from the Halbach array may offset the reduction in flux coupling caused by increasing the distance between the first array of magnetic field generating elements 12 and the coupling elements 32. Increasing the gap between the first array of magnetic field generating elements 12 and the coupling member 30 means that heat production in the region of the first array of magnetic field generating elements 12 from eddy currents and hysteresis effects may be kept further from the coupling elements, which may lead to improved performance. It may also ease the removal of heat.

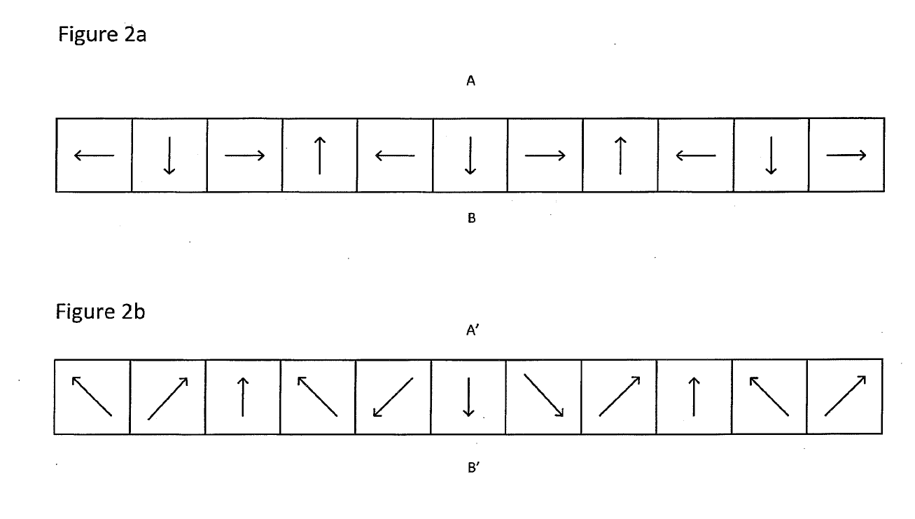

A first example of a Halbach array is shown in FIG. 2a, in which the relative orientation of consecutive magnetic poles of the array is rotated by 90° as indicated by the arrows in FIG. 2a. FIG. 2b shows a second example of a Halbach array, in which the relative orientation of consecutive magnetic poles of the array is rotated by less than 90°, for example by approximately 45°, again as indicated by the arrows in FIG. 2b. The arrays shown in FIGS. 2a and 2b provide augmented magnetic fields on sides A and A′ of the respective arrays and weak or substantially zero fields on the sides B and B′ of the respective arrays.

Providing the first array of magnetic field generating elements 12 as a Halbach array oriented such that the high flux side A or A′ faces radially outward of the first member, i.e. away from the chamber 40, concentrates heat generated by hysteresis and eddy currents on the outside of the first member 10 and away from the chamber 40, which enables the heat to be more easily removed.

FIG. 3 shows a very diagrammatic representation of a vehicle 200 with a flywheel 230 energy storage system coupled to a vehicle drive 208, comprising the vehicle engine and drive transmission, by a magnetic gear 100 as shown in FIG. 1. The details of the coupling of the flywheel 230 to the vehicle drive 208 to allow energy storage and energy regeneration may be of conventional form and so will not be described. The engine of the vehicle drive may comprise any suitable engine, such as a standard internal combustion engine.

As shown, in FIG. 3 the vehicle drive 208 is coupled to a controller 202 (which may constitute or be part of the vehicle drive management system), the controller 202 itself coupled to a rotational drive 210 that is coupled to control rotation of the second member 20 of the magnetic gear of FIG. 1. The first member 10 comprises a sensor 14 for sensing a rotational speed of the first member 10 and the second member 20 comprises a sensor 24 for sensing a rotational speed of the second member 20.

The first and second sensors 14, 24 may comprise tachometers or other instruments capable of measuring a rotational frequency. The sensors 14, 24 may, for example, comprise Hall Effect sensors or may otherwise be contactless sensors, for example by using a magnetic coupling to avoid mechanically interfering with the rotating members 10, 20. For example, the first sensor 14 may be configured to sense the first moving magnetic field through the radial extent of the first member 10 and second sensor 24 may be configured to sense may be configured to sense the second moving magnetic field through the radial extent of the second member 20. For example, the first sensor 14 may be mounted on an outer surface of the first member 10 (the surface away from/not carrying the first magnetic field generating elements 12) and the second sensor 24 may be mounted on the inner surface of the second member 20 (the surface away from/not carrying the second array of magnetic field generating elements 22). Alternatively, at least one of the first and second sensors 14, 24 may be provided on surfaces adjacent the first and second members 10, 20 respectively. For example, the first sensor 14 may be mounted on a surface of the first housing member 60 or on or in a surface of the coupling member 30, and the second sensor 24 may be mounted on or in a surface of the coupling member 30. Mounting the sensors elsewhere than on or in the first and second members 10, 20 may also help to avoid compromising the structural integrity of the first and second members 10, 20 respectively.

The rotational drive 210 may be provided by at least one of a hydraulic pump of the vehicle, a motor or a CVT.

The controller 202 is arranged to determine a power demand requirement of the vehicle drive 208. The sensor 14 of the first member 10 is arranged to provide the controller 202 with a first sensor signal indicating the rotational speed of the first member 10. The sensor 24 of the second member 20 is arranged to provide the controller 202 with a second sensor signal indicating the rotational speed of the second member 20. The controller 202 is arranged to control the speed of the second member 20 based on the first and second sensor signals by controlling operation of the rotational drive 210, which is arranged to increase or decrease the torque on the second member 20.

The controller 202 comprises memory and a processor. The memory is configured to store data representing the gear ratio of the magnetic gear n/m. A programmable interface may be provided to allow a user to input the gear ratio into the memory. The controller 202 is configured to access the gear ratio stored in the memory and to determine whether or not the magnetic gear is synchronously coupled by comparing the first and second sensor signals to the gear ratio. Alternatively, the controller 202 may determine whether or not the magnetic gear is synchronously coupled without reference to the gear ratio by dividing the second sensor signal by the first sensor signal, in which case the return of a constant output would indicate synchronous coupling and a non-constant output would indicate the absence of a synchronous coupling. For example, a rapid change in the output could indicate the system “breaking away” from synchronicity. In this example, the controller 202 may not be configured to store the gear ratio. The processor may be embodied in hardware, software, firmware or any combination thereof. The processor could, for example, comprise a printed circuit board.

In operation, the vehicle drive 208 experiences a power demand requirement when additional power is required by the vehicle drive 208. The controller 202 determines the power demand requirement, for example based on data representing at least one of engine efficiency, vehicle speed the amount of energy stored in the flywheel and, in response, determines whether or not the flywheel 230 is able to return power to the drive system by determining whether or not the magnetic gear 100 is synchronously coupled. If the controller 202 senses that the magnetic gear 100 is synchronously coupled, the controller 202 controls a transfer of power form the flywheel to the drive system. If the controller determines that the magnetic gear 100 is not synchronously coupled, which optionally includes determining that the magnetic gear 100 remains uncoupled for a predetermined period of time, then the controller 202 controls an operation to couple or recouple the magnetic gear 100. To (re)couple the magnetic gear 100, i.e. to (re-)establish synchronous relative rotation between the first and second members 10, 20, the controller 202 controls the pump 210 to provide an increase in torque to the second member 20 for a limited time period to cause the speed of the second member 20 to increase beyond the speed associated with synchronicity, as determined by the speed of the first member 10 and the gear ratio n/m. The second member 20 is then allowed to slow down to the speed associated with synchronicity via natural dissipation of energy, e.g. through windage, frictional or heat losses. The controller 202 then makes another determination of whether the magnetic gear 100 is synchronously coupled. If a synchronous coupling is determined, the controller 202 controls a transfer of power from the flywheel 230 to the drive system, if not, the recoupling operation is repeated.

During the running of the vehicle 200, there may be occasions where it is necessary or advantageous to decouple the magnetic gear 100 to decouple the flywheel 230 from the vehicle drive 208. This may particularly be the case where the vehicle 200, or a part of the vehicle which is driven by the vehicle drive 208, for example a pneumatic arm of a digger, comes to rest after a period of locomotion. A reduction in speed of the vehicle 200 or the driven part thereof, causes a decrease in the speed of the first member 10 which results, if the synchronous coupling is maintained, in a consequential loss of energy from the flywheel 230. To address this problem, the controller 202 is configured to decouple the synchronous coupling to decouple the flywheel 230 from the drive system to preserve the energy stored in the flywheel through low speed or rest periods of the driven parts of the vehicle.

To perform the decoupling, or “declutching”, operation on the magnetic gear 100, the controller 202 determines a lower power demand requirement, including determining a requirement for declutching, from the vehicle drive 208. The controller 202 then determines whether or not the magnetic gear 100 is synchronously coupled. If the magnetic gear 100 is synchronously coupled, the controller 202 controls the pump 210 to change the speed of the second member 20 to move the second member away from the speed associated with synchronicity. The controller 202 causes the pump 208 to maintain the speed of the second member 20 at a speed other than that associated with synchronicity until the controller 202 determines that the power demand requirement of the drive system has increased, or until the controller 202 otherwise determines that the requirement for clutching the gear has ceased. The controller 202 then initiates a recoupling operation to re-establish the synchronous coupling. Decoupling the gear may assist energy preservation by reducing drag on the flywheel as the input rotor and first member 10 slow down, for example. This may also help to reduce wear on the second bearings 70c,d.

Establishing or re-establishing a synchronous coupling may be assisted, or alternatively may be provided, using a magnetic gear in which a squirrel cage is fixed for rotation with one of the first and second members.

FIG. 4a shows an example of a squirrel cage 14 which may be incorporated into one of the first and second members 10, 20 of the magnetic gear 100 shown in FIG. 1. The squirrel cage 14 comprises an array of electrically conductive elements 16 coupled together at their ends by electrically conductive coupling elements 18. The electrically conductive coupling elements 18 couple first and second ends of each of the electrically conductive elements 16 to first and second ends of a consecutive electrically conductive element 16. In this way, a plurality of electrically conductive circuits comprising consecutive coupling elements 16 and portions of the electrically conductive coupling elements 18 therebetween are provided.

FIG. 4c shows an axial cross section through the first member 10′ modified to incorporate the squirrel cage of FIG. 4a between first and second ends of the first member 10′, the first and second ends corresponding to the position of the coupling elements 18 shown in FIG. 4a. (The coupling elements 18 are therefore not visible in the illustrated cross section.) The first member 10′ of FIG. 4c comprises non-conductive material 19, a first array of magnetic field generating elements 12 and the squirrel cage 14. Respective electrically conductive elements 16 of the squirrel cage 14 are provided intermediate consecutive magnetic field generating elements 12 and are separated therefrom by the non-conductive material.

A schematic illustration of the first array of magnetic field generating elements 12, of the kind described in relation to FIG. 1, is shown in FIG. 4b.

Each of the magnetic field generating elements 12 is received in a recess in the non-conductive material as described in relation to FIG. 1.

In operation, rotation of the first member 10 comprising the squirrel cage 14 relative to the second member 20 causes the electrically conductive elements 16 to move through magnetic flux arising from the second array of magnetic field generating elements 22. When the first member 10 rotates non-synchronously relative to the second member 20, the electrically conductive elements 16 couple to the magnetic flux arising from the second array of magnetic field generating elements 22 and electrical currents are induced in the squirrel cage. The movement of the electrical currents relative to the magnetic field of the second member 20 creates an increase in torque and a consequential increase in the relative speed of rotation between the first and second members 10, 20. The squirrel cage 14 generates an increase in torque, beyond the torque arising from the magnetic coupling, for as long as the relative rotation of the first and second members 10, 20 remains non-synchronous. The increased speed of relative rotation provided by the squirrel cage brings, or helps to bring, the gear 100 into synchronicity as explained above.

The squirrel cage of FIG. 4a, 4c may be used in conjunction with the clutch control described in relation to FIG. 3. Those skilled in the art will appreciate that the torque created by the squirrel cage 14 will help the gear 100 to re-establish synchronicity during a recoupling operation, and therefore lower or remove the requirement for the pump 210 shown in FIG. 2.

While FIG. 4c shows the squirrel cage 14 incorporated with the first member 10, it will be appreciated that a coupling between the squirrel cage 14 and the second array of magnetic field generating elements 22 could be achieved by fixing the squirrel cage 14, or a similar electrically conductive structure, for rotation with the first member 10 in any appropriate way.

It will be appreciated that a squirrel cage could be incorporated in either or both of the first and second members 10, 20. Hysteresis and eddy current losses generated by the squirrel cage 14 however, mean that it may be preferable to locate the squirrel cage 14 on or with the member outside of the chamber, i.e. on or with the first member 10, so that any additional heat may more easily be removed from the magnetic gear 100.

Either or both of the first and second arrays of magnetic field generating elements 12, 22 described herein could be provided by a Halbach array.

It will be appreciated that any feature described in relation to one of the first and second members 10, 20, could in other examples be provided in the other of the first and second members 10, 20.

In some examples, the coupling member 30 have a “top hat” geometry, comprising a circumferential wall 36, a “top” 34 and a “rim” 38, as shown in FIG. 2. The view shown in FIG. 1a is a cross-section through the circumferential wall 36. By locating the second member 20 inner of the circumferential wall 36 and the top 34 and the first member 10 on the outside of the circumferential wall 36 and top 34, and by sealing the rim 38 of the top hat to a housing wall of the chamber 40, the coupling member 30 may provide a barrier which seals the second member 20 from the first member 10. This may reduce the transmission of perturbations across the magnetic coupling. When the barrier is a sealed barrier with a sealed coupling to the wall of the chamber 40, a sealed chamber 40 may be provided. The chamber may be at vacuum or low-pressure chamber or may contain a low viscosity gas such as Helium. Housing the second member 20 in such a chamber may reduce “windage” and other frictional losses. The “top hat” coupling member 30 may be symmetrical about its axis of rotation. In other examples the “top hat” coupling member 30 may be asymmetrical about the axis of rotation of the magnetic gear 200. The coupling member 30 may have a lug which is configured to engage with a corresponding recess in the housing of the magnetic gear (for example in the first housing portion 60 or second housing portion 70) for securing the coupling member 30 in place relative to the housing. When a passive pump is used, it may be the case that a controller and sensors are not required.

While the coupling elements 32 of the coupling member 30 are described as being provided in recesses of the outer surface of the coupling member 30 and beneath the inner surface of the coupling member 30, in other examples, the coupling elements could be provided on either or both of the outer and inner surfaces, could be partially embedded in one of the outer and inner surface, could be flush with one or both of the outer and inner surfaces of could be fully embedded within the coupling member 30.

While the above disclosure describes a step-up gear, it will be appreciated that may aspect of the disclosure could be applied to a step-down gear.

While a vacuum or low pressure chamber is described, it will be appreciated that in other examples the chamber may not be low pressure and may not be sealed. In another example, the chamber 40 may contain a gas other than air, in particular a gas having a lower viscosity than air, such as Helium. In the above description, the high speed (second) member 20 is described as being contained in a chamber, but in other examples the low speed (first) member 10 may be provided within a chamber. In other examples, no chamber is provided.

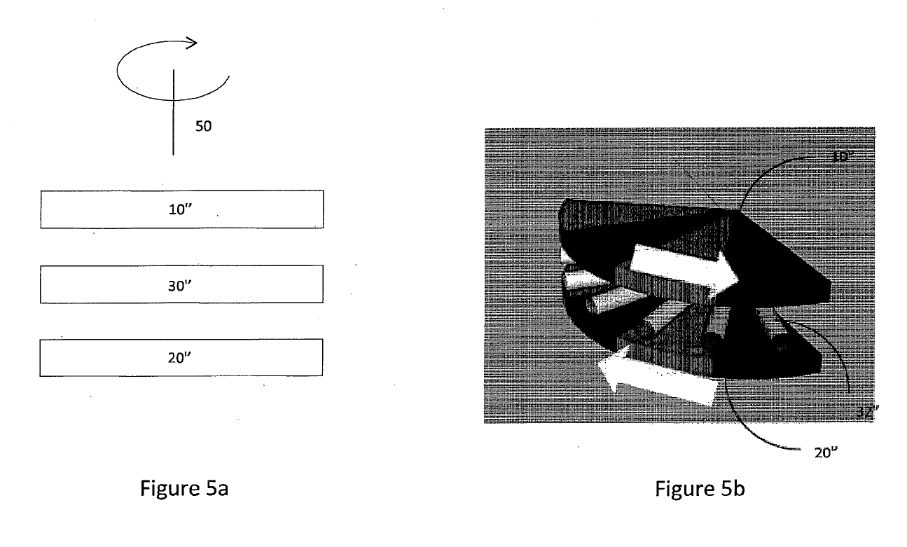

While the above disclosure is couched in terms of a concentric magnetic gear, those skilled in the art will appreciated that a magnetic gear could be provided in which the first and second members are axially spaced apart, and in which the coupling member is provided intermediate the first and second members for coupling magnetic flux between the first and second arrays in an axial direction. The first and second members of such a magnetic gear would preferably be arranged coaxially, although non-coaxial arrangements are possible. An example of such an arrangement is shown in FIGS. 5a and 5b. FIG. 5a shows a cross section through a diameter of a non-concentric magnetic gear, having a first member 10″, coupling member 30″ and second member 20″ all arranged to rotate about the axis 50 as indicated in FIG. 5a. FIG. 5b shows a partial cut-away view of the same non-concentric magnetic gear showing the first and second members 10″, 2022. The coupling member 30″ is not shown, instead the coupling elements 32″, are visible.

In another possibility, a linear gear may be provided, in which the first array of magnetic field generating elements 12 is provided in a first linear array, the second array of magnetic field generating elements 22 is provided in a second linear array, and the coupling elements re provided in a third array intermediate the first and second arrays. First and second moving magnetic fields may be provided by providing the first and second arrays of magnetic field generating elements by way of first and second arrays of permanent magnetic poles on first and second moveable members respectively, or one or both of the moving magnetic fields may be provided by an array of sequentially activated electromagnets. In a case where the first member is arranged to move, the first (linear) member may be coupled to the input rotor 14 via a rotational to linear converter or actuator, or the first (linear) member may be driven by linear motion. The second (linear) member may be coupled to a flywheel or other rotational output via a linear to rotational converter or actuator or may be arranged to drive linear motion.

It will be appreciated that while the above disclosure is couched in terms of a magnetic gear, aspects of the disclosure are also applicable to a magnetic coupling having a 1:1 torque transmission ratio. A coupling member 30 and/or coupling elements 32 may not be required in such a magnetic coupling.

While in the above disclosure the arrays of magnetic field generating elements are provided by permanent magnetic poles, in applications of a magnetic gear or coupling which do not require rotation of both of the first and second members 10, 20, the array of magnetic field generating elements of a non-rotating one of the first and second members could instead be provided by an array of electromagnets. For example, the array of electromagnets could be configured to provide a moving magnetic field by the application of a multiphase current to the array of electromagnets.

Referring to FIG. 3, although the magnetic gear and control arrangement has been shown in the context of a vehicle, the magnetic gear and the control arrangement which is described may be coupled to any other drive transmission. For example, a magnetic gear or coupling as described herein could be applied to a pump system, a turbine system or any system using a flywheel to manage a power requirement of the system.

It will be appreciated that elements described herein in relation to a given embodiment herein could be used in another embodiment, and that modifications and variations within the contemplation of that skilled in the art may be made to any of the disclosed embodiments without departing from the scope of the invention as set out in the claims.

1. An energy storage system comprising a magnetic coupling, the energy storage system comprising:
a housing defining a chamber;
a first member arranged outside the chamber, the first member having a first array of magnetic field generating elements;
a second member arranged inside the chamber, the second member having a second array of magnetic field generating elements, the first and second members being arranged for relative movement;
wherein one of the first and second members is coupled to a flywheel;
wherein the chamber may be at vacuum or low pressure; and
wherein at least one of the first array of magnetic field generating elements and second array of magnetic field generating elements comprises a Halbach array.

2. The energy storage system of claim 1, wherein the orientation of consecutive permanent magnetic poles in the Halbach array varies by less than 90 degrees.

3. The energy storage system of claim 1, further comprising a coupling member, the coupling member being configured to couple magnetic flux between the array first array of magnetic field generating elements and the second array of magnetic field generating elements.

4. The energy storage system of claim 3, wherein the first member, coupling member and second member are arranged concentrically, wherein wherein the coupling member is provided intermediate the first and second members for coupling magnetic flux between the first and second arrays in a radial direction.

5. The energy storage system of claim 3, wherein the first and second members are axially spaced apart, wherein the coupling member is provided intermediate the first and second members for coupling magnetic flux between the first and second arrays in an axial direction.

6. The energy storage system of claim 3, wherein the coupling member comprises a plurality of elements for coupling the flux.

7. The energy storage system of claim 3, wherein the coupling member has an outer circumferential surface.

8. The energy storage system of claim 6, wherein the coupling member has an inner circumferential surface.

9. The energy storage system of claim 1, wherein one of the first and second members is arranged to be coupled to an input rotor of a vehicle and the other is arranged to be coupled to the flywheel, which is arranged for storing energy to power the vehicle.

10. A magnetic coupling, comprising:
a first member having a first array of magnetic field generating elements, the first member being arranged to produce first moving magnetic field;
a second member having a second array of magnetic field generating elements, the second member being arranged to produce second moving magnetic field, wherein the first and second members are arranged for relative movement therebetween; and
a controller configured to determine whether or not the first and second moving magnetic fields are synchronously coupled and to control the speed of at least one of the first and the second moving magnetic field to control coupling and decoupling of the magnetic coupling.

11. The magnetic coupling of claim 10, wherein the controller is configured to track at least one of:
the speeds of the first moving magnetic field and the second moving magnetic field; and
the speed of relative movement of between the first member and the second member.

12. The magnetic coupling of claim 10, wherein the controller is configured, in response to determining that the first and second moving magnetic fields are synchronously coupled, to cause a change in the speed of the first or the second moving magnetic field to move the magnetic coupling from synchronicity.

13. The magnetic coupling of claim 10, wherein the controller is configured, in response to determining that the first and second moving magnetic fields are not synchronously coupled, to cause a change in the speed of the first or second moving magnetic field to establish synchronicity.

14. The magnetic coupling of claim 10, comprising:
an array of electrical conductors fixed relative to the first member,
wherein the array of conductors is arranged to inductively couple with the second moving magnetic field to produce a torque to bring the first and second moving magnetic fields into synchronous relative movement.

15. The magnetic coupling of claim 10, comprising a mechanical brake configured to decrease the speed of a moving one of the first and second members.

16. A method of operating a magnetic coupling comprising a first member having a first array of magnetic field generating elements, the first member being arranged to produce first moving magnetic field, a second member having a second array of magnetic field generating elements, the second member being arranged to produce second moving magnetic field, wherein the first and second members are arranged for relative movement therebetween, and a controller configured to control coupling and decoupling of the magnetic coupling, the method comprising:
effecting relative movement between the first and second members;
receiving, at the controller, an indication of the speed of at least one of the first and second moving magnetic fields; and
determining whether or not the magnetic coupling is synchronously coupled based on an indication of the speed of the at least one of the first and second moving magnetic fields and controlling the speed of at least one of the first and second moving magnetic fields to couple or decouple the magnetic coupling.

17. The method of claim 16, wherein controlling the speed of the at least one of the first and second moving magnetic fields to decouple the synchronous coupling comprises increasing the speed of the second moving magnetic field to take the second moving magnetic field past a speed associated with synchronicity and maintaining the second moving magnetic field at the new speed to prevent recoupling.

18. The method of claim 16, wherein controlling the speed of the at least one of the first and second moving magnetic fields to establish a synchronous coupling comprises increasing the speed of the second moving magnetic field past a speed associated with synchronicity and allowing the speed of the second moving magnetic field to slow down to the speed associated with synchronicity.

19. The method of claim 16, wherein the magnetic coupling comprises a magnetic gear, the method comprising determining the whether or not the magnetic coupling is synchronously coupled based on the indications and a gear ratio of the magnetic gear.

20. The method of claim 16, comprising determining a power demand requirement of a drive system to which the second member is coupled and controlling the speed of the at least one of the first and second members based on the power demand requirement.
